(19) United States
(12) Patent Application Publication
(10) Pub. No.: US 2004/0098240 A1
(43) Pub. Date: May 20, 2004

(54) State machine modelling

(75) Inventor: Graham G. Thomason, Redhill (GB)

Correspondence Address: Corporate Patent Counsel, U.S. Philips Corporation, 345 Scarborough Road, Briarcliff Manor, NY, 10510, US

(73) Assignee: KONINKLIJKE PHILIPS ELECTRONICS N.V.

(21) Appl. No.: 10/712,371

(22) Filed: Nov. 13, 2003

(30) Foreign Application Priority Data
Nov. 16, 2002 (GB) 0226805.0

(51) Int. Cl. G06F 17/50

(52) U.S. Cl. 703/17

(57) ABSTRACT

To handle non-determinism in a state machine model, different non-deterministic outcomes are represented in a system by ‘worlds’. A world represents the state, history and variable values result of event processing for every permutation occasioned by non-determinism. The system clones a world (233) so as to represent a sequence uniquely. When any two resultant worlds are identical, one is deleted (235). When plural worlds exist, the system accepts an event for processing and processes the event in all of the extant worlds (232, 234). The embodied system causes the generation and processing of a set of transition sequences based on fork and race-condition non-determinism for each extant world. The system allows permutation of set-transit actions, and generates additional worlds for each permutation. The system also allows for mid-transition-flight firing of additional events, which results in additional worlds in which the remainder of the transition algorithm is processed. The system also has supporting functionality, including the ability on request to output all transitionable events, to provide all state, variable and history data, and to validate state, variable and/or history information.

This invention relates to a method of modelling a state machine. The invention relates also to a computer program for instructing a computer to carry out the method, and to a computer programmed with such a computer program.

The increasing complexity, size and lead time of software systems is a concern to the software industry. One solution which addresses these concerns is the component-based synthesis of systems. Components provide for system modularity, customisability, maintainability and upgradeability. Large systems can be built by selecting components from repositories and binding them together, rather than by writing systems without code reuse.

This approach to system building presents problems in terms of the testing of the operation of the system, although the testing of the individual components is relatively straightforward. Currently available testing tools rely on a tester generating a state machine model of the system under test. The model and the system under test are then subjected to a test, and the resultant state of the model and the system compared to determine if the system performed as expected. This procedure is repeated until the system has been fully tested.

An explanation of state machines and how they are modelled now follows. It will be appreciated that the notation and the syntax used is illustrative and non-limiting. The following also describes how models are used for system testing.

Many systems can be modelled according to their state behaviour, that is their state and how the state changes as a result of some stimulus or signal, called an event. Under this modelling technique, if a system is in a given state, it will remain so indefinitely until an event occurs. The notion of a state therefore entails durability—the state exists over a period of time. Even if a system enters a particular state s1 and there is an event ready and waiting to cause a change of state (to state s2), the moment when the system is in state s1 is a point at which the system is stable in terms of its state behaviour. At such a point, the state of the system (in a wide sense) will map to a state in the model of the system.

Events are modelled as instantaneous signals which have no duration. They are able to trigger some processing in the system which may or may not result in a new state. In some states, events may be ignored by the system, leaving the system in its existing state.

A system may be of the kind that theoretically runs indefinitely, such as an operating system or real-time kernel, or it may have a clear lifecycle. owever, even operating systems can generally be closed down in a controlled way.

A multi-threaded application might be modelled with states which represent the fact that low priority threads are running. Such a system would still be able to react to events which interrupt at a higher priority. It may even be necessary to represent cpu (central processing unit) bound tasks as states, perhaps using several states so as to model events as having been recorded but unable to be processed until the task completes.

Input data to a program can also often conveniently be thought of as a sequence of events. In this case, the program will normally have instant access to the next event (apart from an occasional disc-access or similar), and so will be cpu-bound, but this does not detract from the state model. An example of such a kind of program is a conversion program to convert texts from one kind of character coding to another, perhaps with situations where one character of input maps to two characters of output and vice versa. The input characters (including new lines and end-of-file) can be modelled as events. Output characters will be generated on certain state changes. Another example is a compiler where the input tokens can be regarded as events; the state is some record of completed successful parsing of ‘terms’ in production rules.

If two states show identical responses to any sequence of events that is processed from a system in such a state, then they are indistinguishable and are best modelled as one state, so as to avoid redundancy in the model.

In order to model a system, it is necessary to express all the relationships between states, events, and new states after processing the event. A transition maps a source state to a new state (the target or destination state) by means of an event. In effect, the event triggers the transition. A diagram showing states and transitions is termed a state-transition diagram. States are conventionally denoted by circles, and transitions by arcs with an arrowhead. Transition arcs conventionally are annotated with the events that cause the transition. FIG. 1 shows a system having three states: a, b and c; four events: α, β, γ, and δ; and four transitions: t1, t2, t3 and t4.

At any one time, a system modelled by the FIG. 1 state-transition diagram will be in only one state. That state is called the occupied (or active) state. The others are vacant (or inactive). Transitions whose source states are vacant at the time an event occurs do not cause any state transitioning to take place—they are inapplicable in the current state. If an event occurs which is the trigger to a transition whose source state is occupied, then (apart from non-deterministic situations) the transition takes place. Here, the source state becomes vacated and the target state becomes occupied. In the FIG. 1 example, when the system is in state a, it reacts to event α by executing transition t1, i.e. by transitioning from state a to state b. If the system is not in state a, then transition t1 is not applicable because the system is not in t1's source state. Only one transition takes place as a result of one occurrence of this event, so transition t2 does not take place as well, unless and until another event α occurs. It will be appreciated that there can be several transitions emanating from any state (for example t1 and t3 from state a). Also, an event can be a trigger to more than one transition (for example a triggers t1 and t2), but, (excluding non-determinism), it is not usual to find two transitions triggered by the same event from the same source state. Furthermore, a transition can be triggered by more than one event, in which case any one of the events will trigger the transition. For example, transition t3 is triggered by event β or δ. If an event occurs which does not trigger a transition, (for example if in state b event β occurs), then the event is disregarded and no state change occurs.

The way in which the state transition diagram of FIG. 1 is represented in a possible source code language is:

statechart sc(s)

event alpha,beta,gamma,delta;
cluster s(a,b,c)

state a {alpha->b;beta,delta->c;}
state b {alpha->c;}
state c {beta,gamma->a;}

Here, the state transition diagram is declared as a “statechart”, which consists of a cluster s, which consists of three states or leafstates a, b, and c. A cluster indicates a grouping in which no more than one member state can be occupied. Events are declared and are used in transitions, which are denoted by

events -> target state;

State behaviour modelling is part of the UML (Unified Modelling Language) dynamic view.

An implementation of a state based model of a system provides a way to automatically generate test cases for that system. According to a white-box technique, this can be set up is for a test script (TS) to communicate with the State Behaviour Model (SBM) and the Implementation Under Test (IUT), giving each instructions to put themselves in a particular state, to process an event, and to provide their new state. The test script then compares the new states as reported by each. Any mismatch is a test failure and so possibly the detection of a bug in the IUT (although it could be a modelling error, a test script error, or even a bug in the SBM). The instruction sequence is repeated for as many states and events as it is feasible to execute. A certain amount of glue-code is be needed to communicate with the IUT.

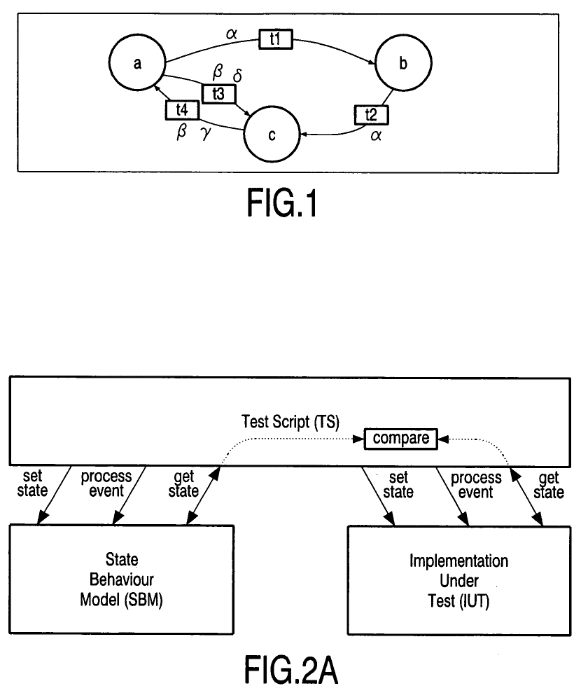

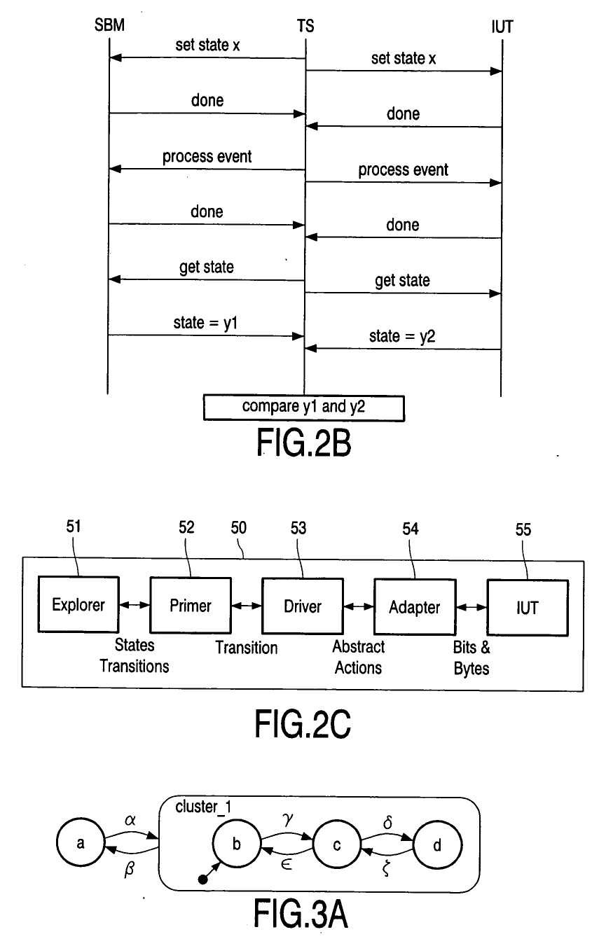

The SBM resultant state is termed the ‘oracle’ to the test, i.e. it is the expected result from the IUT. The process is illustrated in FIGS. 2A and 2B.

This technique is called white-box because it requires knowledge of the internals of the IUT in order to communicate with it in this way. Black-box techniques also exist in which the IUT is entirely event driven and its behaviour is deduced from limited observed output traces which are generated on certain transitions. In this case, transition tour algorithms provide some form of coverage of the state space.

Coverage of all states and events is obtained by looping as follows:

For all states

For all events

Set state in SBM and IUT

Process event in SBM and IUT

Get state of SBM and IUT

Compare resultant states

This does not guarantee the correct state behaviour of the IUT—it is possible that it could show incorrect behaviour in some states under some circumstances—e.g. entering a state via one route might give rise to different subsequent state behaviour than the state behaviour when the same state is reached via a different route. Other test generation algorithms can be designed to give further coverage, for example covering all pairwise event combinations.

FIG. 2C illustrates a test case generator 50. It includes in a chain an explorer 51, a primer 52, a driver 53, an adapter 54 and an implementation under test 55. Each device has a bi-directional communication link with adjoining devices. The explorer 51 is a state machine system, that offers and processes transitionable events, and provides state (or trace) information to the primer 52. The primer 52 gives to the explorer 51 instructions such as ‘get state’, ‘tell me what events trigger the transitions possible from the current state’ or ‘process the following event’. The primer 52 may contain a test generation algorithm, allowing the state space to be toured during testing. The driver 53 converts abstract items, such as event or state names, to concrete items, and the adapter 54 interfaces to the IUT 55 at a ‘bits and bytes’ level.

Tests are preferably called in a uniform way, and each test should provide its own pass/fail criterion. The test report should produce a uniform description of whether each test passed or failed. A tool providing facilities for doing this is called a test harness.

A more detailed explanation of state machines follows. The example state machine of FIG. 1 contains three leafstates which are “wrapped” in a cluster. A cluster is a group of states (members of the cluster) such that at most one member state can be occupied. If one member is occupied, the cluster is regarded as occupied. If all members are vacant, the cluster is vacant. The members of a cluster can be other clusters, sets or leafstates. The diagrammatic notation for a cluster is a rounded rectangle with its name at the top left. One member of the cluster is designated the default member (symbol [symbol] ). If and when the cluster is initially entered or is the target state of a transition then, unless other factors come into play, the default state is entered.

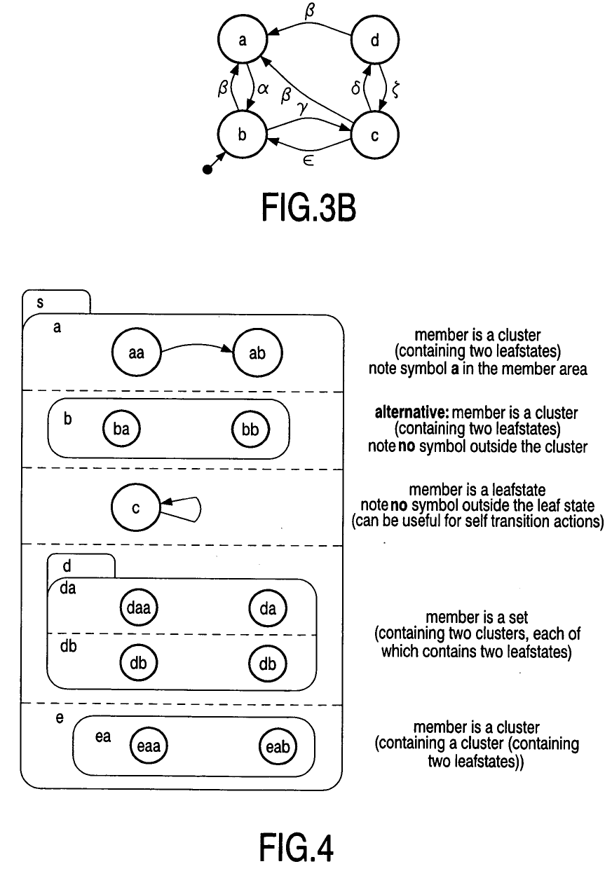

Transitions can have a cluster as their source state. They can also have a cluster as a target state. This gives a compact way to express what would otherwise be multiple transitions. An example cluster is shown in FIG. 3A. The equivalent flattened state machine is shown in FIG. 3B.

A cluster can be marked with a history or deep history marker. The history data records the member that was occupied when the cluster was last occupied. On diagrams, history is marked according to the following legend:

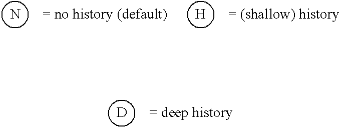

A cluster with a history marker, when entered without a specific member being specified, will enter the historical state. If history data is not available, the default state will be taken. Deep history indicates that historical data is to be used (assuming it is available) on re-entering the cluster and all descendant clusters below the marked cluster. The descendant clusters are entered under a deep history obligation—whether or not they have a history marker. The deep history obligation is not applicable simply because a particular cluster is below another one with a deep history marker. It must be the case that the cluster with the deep history marker is actually entered in the course of the transition for the deep history obligation to apply. History data can be cleared by a function call.

A set is another means by which states can be grouped hierarchically. If a set is occupied, all its members must be occupied. If the set is vacant, all its members must be vacant. The members of a set can be clusters, sets or leafstates. A set normally has at least two members, which provides a statechart with concurrency (i.e. parallelism): several states can be occupied in parallel. The notation for a set is a rounded rectangle with a tab. Members of a set are separated by a dotted line. A separate enclosing rectangle around the cluster is not required; the symbol in the member area but not in any other symbol indicates a cluster. FIG. 4 shows how members of sets can be designated.

A set cannot be marked with a history marker, since there is no choice as to which member to enter—if a set is entered, all of its members are entered. A set can be marked with a deep history marker. This means that on entry into the set and then into the set members, a deep history obligation will be passed on to all members of the set. Any clusters below the set in the hierarchy will then be entered in their historical state.

Other features in state machines are listed here:

Conditions on transitions. For example, ‘α[V1>=V2]’ on a transition means that the transition will only be made on event α if V1 is greater than or equal to V2. The conditions may be C-like boolean expressions, and may contain tests for the occupancy/vacancy of other states.

Actions on transitions, including firing additional events, executing embedded imperative code (such as C code). For example, ‘α/fire f1’ on a transition means that event α will trigger the transition, and the transition will fire event f1.

Lambda-events, i.e. events that are generated automatically (typically by forward chaining) when some condition becomes true such as when some variables take on some particular values.

Meta-events, i.e. events which take place when some micro-step in transition processing takes place, such as entering or exiting some particular state.

Use of scoping operators. It may be desirable to allow e.g. state, event, and variable (and, for a typed language, tag-) and other names to be identical, but to be scoped to different parts of the state hierarchy. A rough similarity comparison can be made with global and class member variables in C++, where the :: operator accesses the global variable, but in a statechart precision is required down at any hierarchical level. Scoping operators give access to the desired target name. Possible scoping operators are

. descend (diadic, right-associative, infix, higher precedence), e.g. a.b.c means descend through state a down through state b to state c.

$ back (monadic, right-associative, prefix, lower precedence). Back out one level and address a state from that level. $$a means back out two levels and enter state a.

:: fromtop (monadic, right-associative, prefix, lower precedence). Back out to the outermost hierarchical level and address a state from that level. ::a.b means enter state a, then from there state b, from the outermost hierarchical level.

%% ancestor (diadic, right-associative, infix, higher precedence). Back out to a named level (the left-hand operand), then enter the state(s) denoted by the right hand operand.

The above operators typically have precedences higher than those of arithmetic operators. Additional operators will be known by those skilled in the art, including operators taking an implicit this-state argument.

Non-determinism is present when a system has freedom of behaviour when responding to an event. Most existing tools for state-based modelling do not handle non-determinism. However, prior art modelling tools that handle non-determinism, such as Concurrency Workbench (available from www.dcs.ed.ac.uk/home/cwb), handle non-determinism by offering the user a choice of transitions. This requires a user to loop over fork non-deterministic choices, and to sequence race-condition sequences manually.

The aim of the invention is improved state machine modelling.

According to a first aspect of the invention, there is provided a method of modelling a state machine, comprising detecting if, from a state, an event gives rise to non-determinism and, if it does, generating a world for at least some of the permutations, and processing the event in each of the worlds.

The term ‘world’ in this sense means a copy of at least part of, but preferably the whole of, the state machine. In the embodiments, each world is independent of all the other worlds, at least until the event has been processed fully. Furthermore, if a further event gives rise to non-determinism in each of plural worlds, then each of these worlds gives rise to plural further worlds.

The generating step may be carried out at any suitable time, for example following an event which leads to non-determinism but before transitioning in response to the event. Preferably, though, the generating step is carried out deep in the processing of transitions.

Preferably the method comprises, following processing of the event, identifying identical worlds and disregarding all except one of the identical worlds.

In the embodiments, where two or more worlds are determined to be identical, as regards leafstate(s), history, variable and trace values as appropriate, they are merged so that only one remains. The other worlds are deleted.

The identification of identical worlds and the deletion of surplus ones may take place after any micro-step (in the transition algorithm) that generates new worlds. Advantageously, this process is carried out after a world has been cloned and a transition has been processed in the clone, and before any other worlds are cloned.

The method preferably comprises processing a further event in all of the extant worlds.

The generating step may comprise permuting or taking a selection of permutations of set-actions. The set-actions might be analogous to set-transit permutations. A set action could be considered as an action in a variable member. It could be a variable assignment, the clearing of history, the writing of a trace or the firing of an event, for example. The permutations may be grouped together according to the level of hierarchy to which they relate.

Alternatively or in addition, the generating step may comprise permuting or taking a selection of permutations of set-meta-events. The term ‘set-metaevents’ will be understood to means events generated internally within a set. Set-meta-events typically occur on the exiting or entering of certain states in a set. The permutations may be grouped together according to the level of hierarchy to which they relate.

Such permuting or taking a selection of permutations allows proper handling of fork, race, set-transit, set-action, set-meta-event and broadcast-event non-determinism either singly or in combination with one or more other types of non-determinism (where permuting is appropriate), and is expected to allow proper handling of other kinds of non-determinism as well.

The method may comprise receiving a request for information on the state model from an external program, and responding to the request with the requested information. The information might be provided by a primer, for example. The request could relate to information concerning what transitionable events exist from a current state of the model, or to state, variable value and/or history information.

Since the number of permutations can be very large, it may beneficial to select a subset of permutations. A subset of permutations could include only one permutation, such as for example a sequence, or alternatively its reverse. Another subset is a sequence and its reverse. Alternatively, a subset may include all forward cyclic permutations of a sequence, or all cyclic permutations of the reverse of the sequence, or both the forward and reverse cyclic permutations. Different schemes for selecting subsets may be used on different occasions. For example, one scheme may be used to select a subset on a race condition, and another used to select a subset of permutations on a subsequent set-transit non-determinism condition.

The method might comprise receiving an instruction to process an event, and processing the event in response thereto. The instruction might be issued by a primer, for example.

According to a second aspect of the invention, there is provided apparatus for modelling a state machine, the apparatus comprising means for detecting if, from a state, an event gives rise to non-determinism and, means responsive to a positive determination for generating a world for at least some of the permutations, and means for processing the event in each of the worlds.

The apparatus may include means arranged following processing of the event for identifying identical worlds and for disregarding all except one of the identical worlds. The apparatus preferably comprises means for processing a further event in all of the extant worlds. The world generating means may comprise means for permuting or taking a selection of permutations of set-actions and/or means for permuting or taking a selection of permutations of set-meta-events. Means may be provided for responding to a request from an external program for information on the state model with the requested information. Preferably, the apparatus includes means responsive to an event-processing instruction for processing an event.

The apparatus preferably takes the form of a computer, including a processor and memory, provided with a suitable program.

Embodiments of the present invention will now be described, by way of example only, with reference to the accompanying drawings, of which:

FIG. 1 is an example state diagram;

FIGS. 2A, 2B and 2C show how a test script tests an implementation under test;

FIGS. 3A and 3B illustrate the effect of a cluster;

FIG. 4 illustrates set operation;

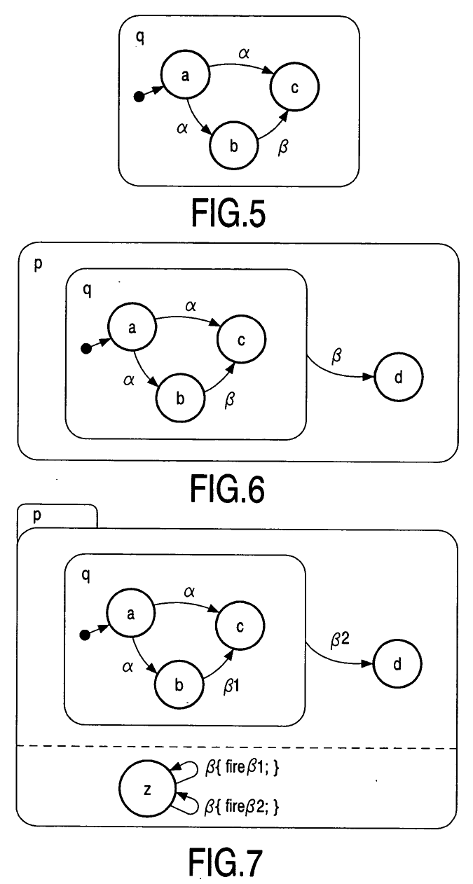

FIGS. 5 to 15 illustrate different types of non-determinism in state machine models;

FIGS. 16 and 17 show cases of fork non-determinism to which the invention is applied;

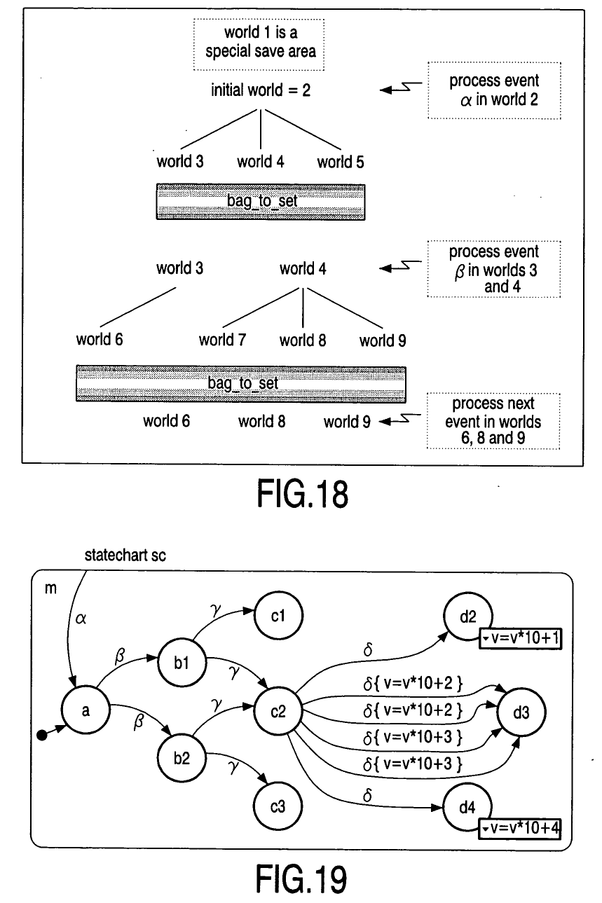

FIG. 18 illustrates processing according to the invention of the model of FIG. 17;

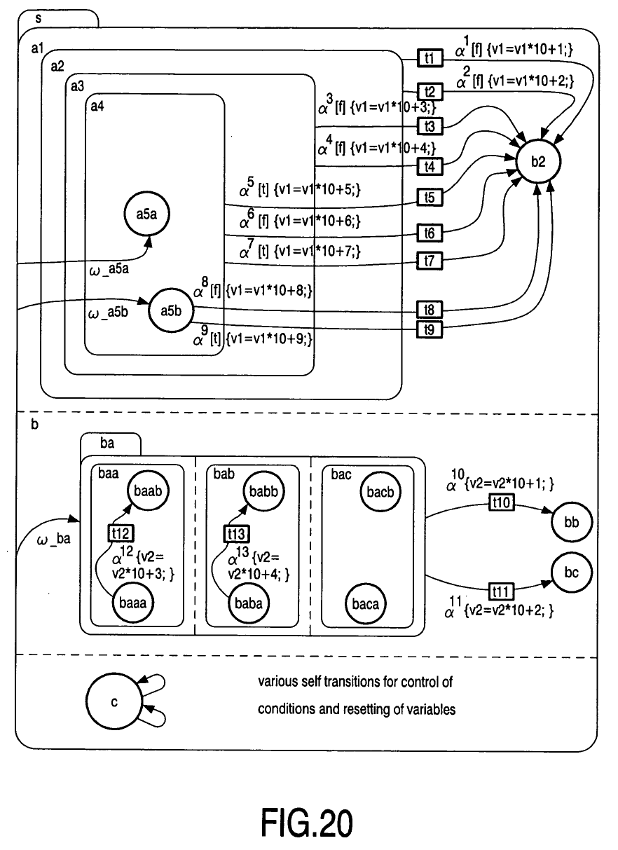

FIGS. 19 and 20 show state models to which the invention is applied;

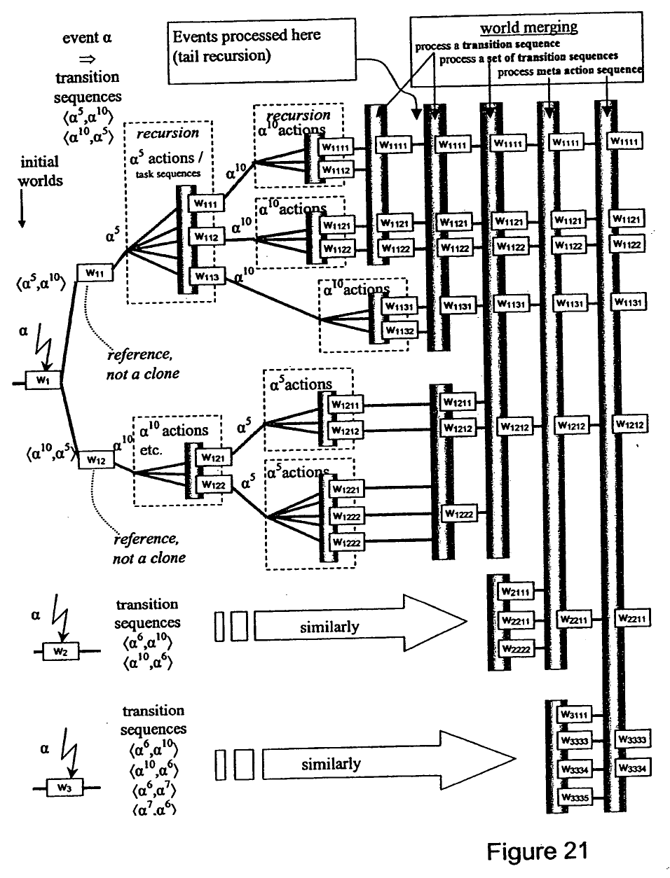

FIG. 21 shows processing according to the invention of the FIG. 20 model;

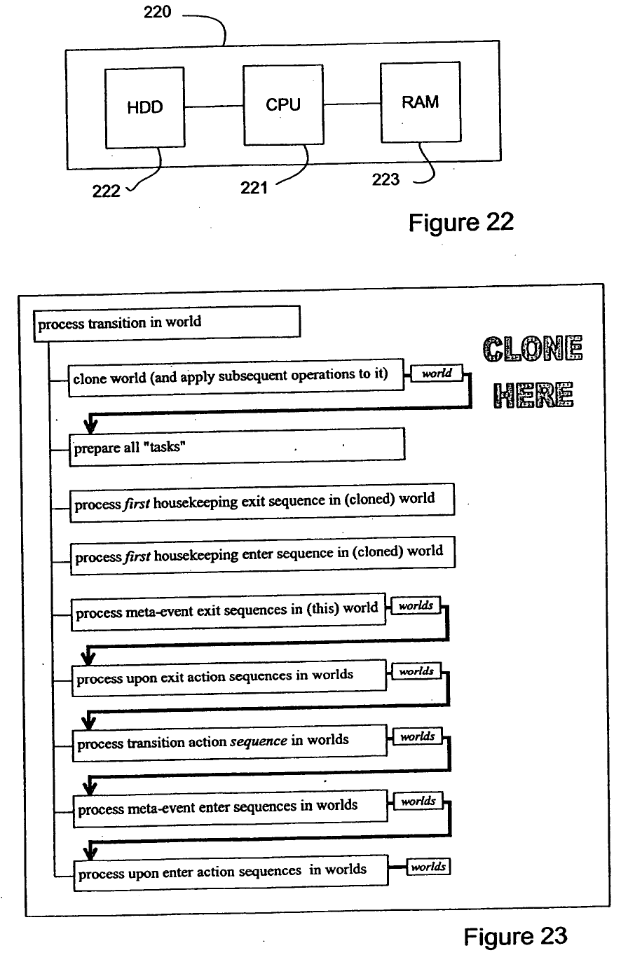

FIG. 22 illustrates computer apparatus according to one aspect of the invention and which allows operation of another aspect of the invention; and

FIG. 23 is a flowchart illustrating a method according to the invention.

The inventor has identified six forms of non-determinism, namely fork, race-condition, set-transit, set action, set meta-event and broadcast event non-determinism. The effects or distinguishing aspects generated by these kinds of non-determinism are state-occupancy distinguished non-determinism, cluster-history-value distinguished nondeterminism, variable-value distinguished non-determinism, and trace-value distinguished non-determinism. These may be referred to collectively as variable-non-determinism, in which case there is never ambiguity as to whether a cause or effect of non-determinism is under consideration.

Fork non-determinism is illustrated in FIG. 5. Referring to FIG. 5, when in leafstate a and event α is processed, two transitions are possible, one ending in state c and the other in state b. These transitions are mutually exclusive; they cannot both be taken, as cluster q is only allowed one active child. If a system is specified with either possibility, then either transition is regarded as being conformant with the specification, i.e. either result would cause a test pass. Not all devices under test will display deterministic behaviour, i.e. always take the same option from a set of alternative options when processing the same event under the same model conditions.

If there were conditions on these transitions (e.g. α[v1==1], α[v2==1]), this would be a case of potential non-determinism. Prior art systems could find a valid transition and handle this potential non-determinism appropriately.

Another form of non-determinism is illustrated in FIG. 6. Referring to FIG. 6, the transition from leafstate b on event β illustrates what has been termed in the art ‘apparent non-determinism’. The outermost transition is defined to be the effective one. However, if there are conditions on these transitions then the inner transition could be taken as the effective one. For example, the instruction β[!in(q.b)] on the outer transition would mean that if b is occupied, the inner transition is taken.

However, it may be desirable to also allow for ‘hierarchical impartiality’, where all transitionable events are treated as non-deterministic possibilities. As this should be an option only, it would involve an addition to the syntax of a transition, for example using a label on the transition. To obtain behaviour equivalent to hierarchical impartiality on event β in FIG. 6 under the hierarchical prioritisation scheme, an extra control state can be introduced, as shown in FIG. 7.

Referring to FIG. 7, it will be seen that the transitions on β from FIG. 6 are renamed β1 and β2. A new member of a set is introduced with self-transitions on event β as shown. These introduce the required non-deterministic behaviour. One fires β1 and the other fires β2, so both cases can be considered by means of ordinary fork non-determinism.

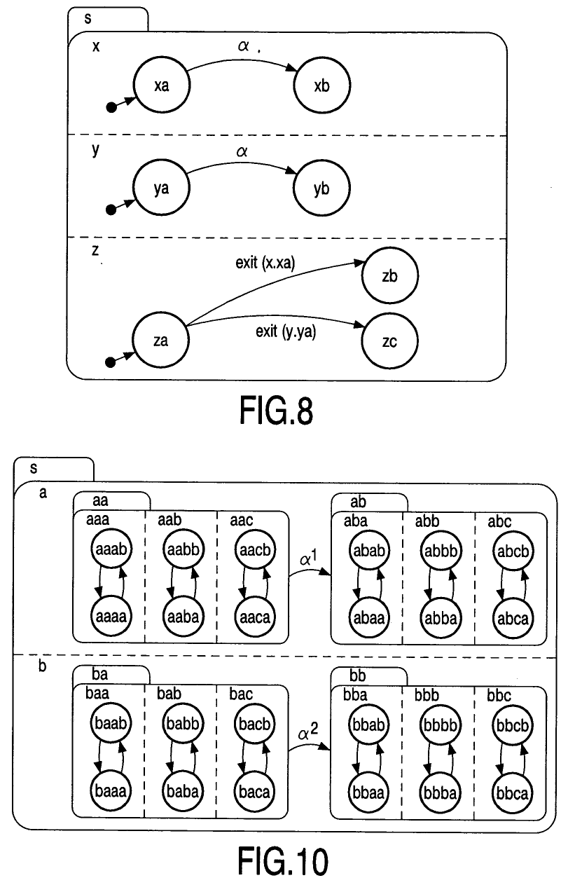

Race-condition non-determinism is illustrated in FIG. 8. Referring to FIG. 8, event α causes a transition in each of two parallel machines, x and y. The order in which these events are processed affects the transition in machine z.

If there are n parallel transitions on an event, there are n!, orderings, which can lead to combinatorial explosion. If certain properties of an implementation are known—for example that it is fact that it is a deterministic implementation (even if it is not known which)— then the combinatorial explosion could be contained by use of suitable exploration/exercising algorithms. Containment of combinatorial explosion can also be realized by taking a good subset of permutations. According to the invention, a subset of permutations can include only one permutation, such as for example a sequence, or alternatively its reverse. Another example of a subset is to take a sequence and its reverse. Alternatively, a subset may include all forward cyclic permutations of a sequence, or all cyclic permutations of the reverse of the sequence. Another example is to take a sequence, its reverse and to take all cyclic permutations of those two sequences.

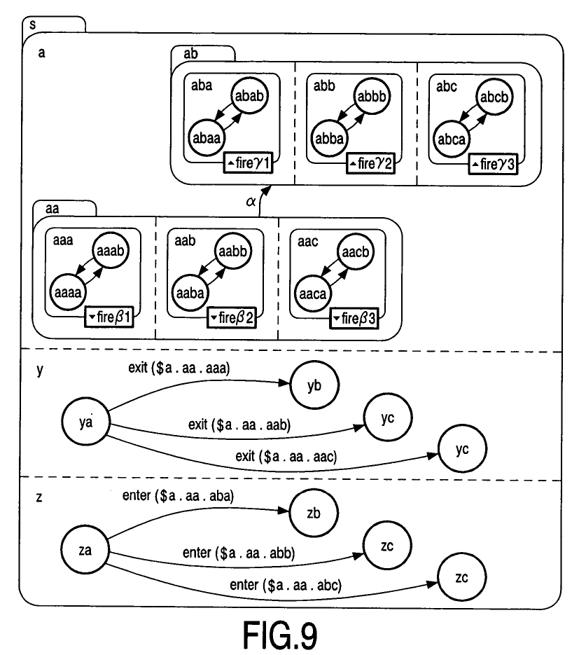

As mentioned above, state machine theory requires that when a set is entered, all its members are entered. The order in which the members are entered is a kind of race-condition leading to set-entry non-determinism. Similarly when a set is exited, we have set-exit non-determinism. These two conditions are collectively termed set-transit non-determinism, which is illustrated in FIG. 9. Here, a set aa forming part of a member a of a set s has three clusters aaa, aab and aac. On an event α, the set aa is exited, and a set ab is entered. However, on an event α, all three members of the set aa are exited, and it will be understood that this cannot occur simultaneously. In this example, the clusters aaa, aab and aac each have a fire event associated with their exit (the point-down triangle denotes this), namely β1, β2 and β3 respectively. These fired events allow the order in which the clusters aaa, aab and aac were exited to be observed. Similarly, clusters aba, abb and abc of set ab should all be entered on event α, and the actual order of entry can be determined from the entry fire events γ1, γ2 and γ3 respectively. In FIG. 9, the first exited cluster is indicated by the end state in cluster γ, and the first entered cluster is indicated by the end state in a cluster z.

It is possible for more than one set to be involved in a set-transit transition, as shown in FIG. 10. In FIG. 10, event α entails the following six exit actions

| | | |
|---|---|---|
| exit(s.a.aa.aaa) | exit(s.a.aa.aab) | exit(s.a.aa.aac) |
| exit(s.b.ba.baa) | exit(s.b.ba.bab) | exit(s.b.ba.bac) |

For these figures, it is ignored that leafstates in these clusters will also be exited, as this does not entail more non-determinism. Rather than considering all 6! (=720) permutations on exit events alone, it would be possible to proceed by generating sequences by permuting the events α¹ and α², generating <α¹,α²> and <α²,α¹>, then in each case permuting the three exit events entailed by each, giving in this case 2.(3!) (=12) orderings.

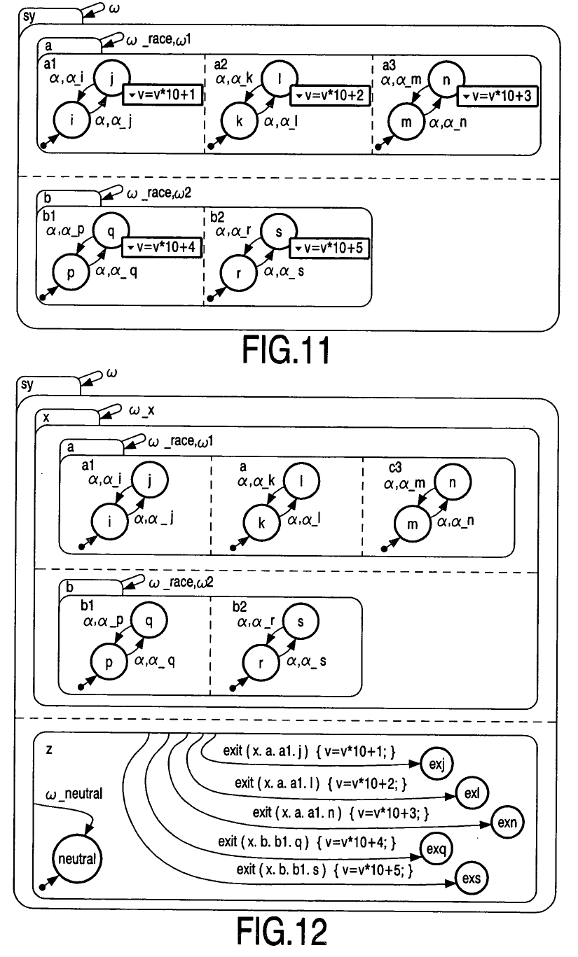

Set action non-determinism is illustrated in FIG. 11. In the state machine of this figure, when events α_j α_n α_s are given, then ω is given. The actions that take place are treated in the same way as set-transit actions on member states.

The event α,α gives rise to race non-determinism on a 5 way race, giving Perm^{race}(5), i.e. 120, possible combinations. Event α,ω gives rise to set-action non-determinism, causing permutations on (exit-j and exit-l and exit-n) and on (exit-q and exit-s), and between them, as if set-transit non-determinism were involved, giving Perm^{set-tran}(2).Perm^{set-tran}(3).Perm^{set-tran}(2)=24 possible combinations. Event α,ω_race gives rise to mixed race and set-action non-determinism, giving Perm^{set-tran}(2).Perm^{set-tran}(3).Perm^{set-race}(2)=24 possible combinations.

Set meta-event non-determinism is shown in FIG. 12. In this figure, analogous comments to those made in connection with set action non-determinism apply. Event sequences give rise to combinations as shown: Event α,α triggers a 5-way race, Perm^{race}(5)=120 possible combinations. Event α,ω_x causes set-meta-event non-determinism, Perm^{set-tran}(2).Perm^{set-tran}(3).Perm^{set-tran}(2)=24 possible combinations. Event α,ω_race gives rise to mixed race and set-meta-event non-determinism, giving Perm^{set-tran}(2).Perm^{set-tran}(3).Perm^{set-race}(2)=24 possible combinations.

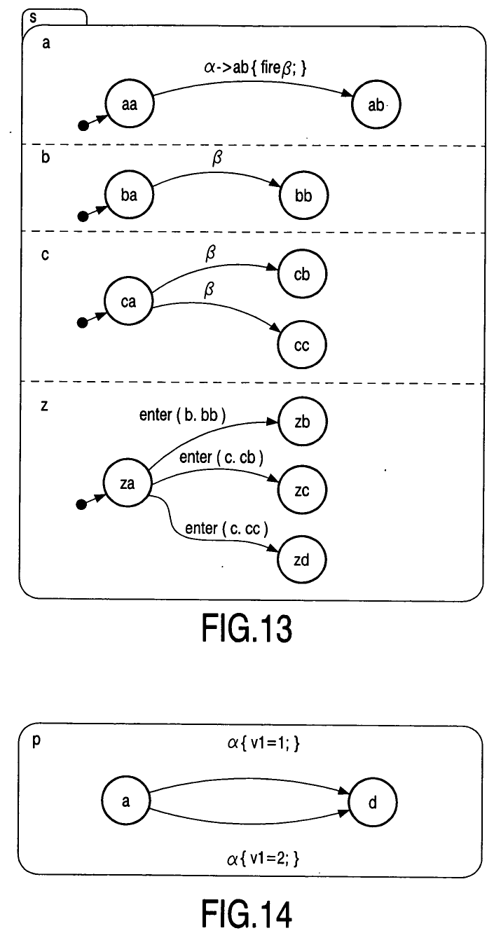

Broadcast-event non-determinism is illustrated in FIG. 13. Broadcast events can also be termed fired events, and the two terms are used interchangeably in this specification. In FIG. 13, an event α fires a broadcast event β, which causes transitions in clusters b and c. The distinguishing feature of broadcast non-determinism is that the processing of alternatives become apparent in mid-algorithm. The non-determinism occurring on a broadcast event may itself be fork, race-condition, broadcast-event or any other kind of non-determinism.

Non-determinism may be manifested by the fact that the possible responses to processing of an event differ in terms of the resultant state, in terms of the value of a variable (termed variable-value non-determinism), in terms of the saved historical state of a vacated cluster (termed history non-determinism) and/or in terms of the value of a trace. These are discussed further below.

Even if two statecharts have the same state occupancy, but with different variable values, the result is that the results that could be generated are distinct. Variable value non-determinism resulting in different variable values is illustrated in FIG. 14. Here, an event α fires two transitions from leafstate a to leafstate b, each transition giving a different value to variable v1. If instead of v=1; and v=2; the transitions included trace(x); and trace(y), FIG. 14 would show nondeterminism distinguished by trace value.

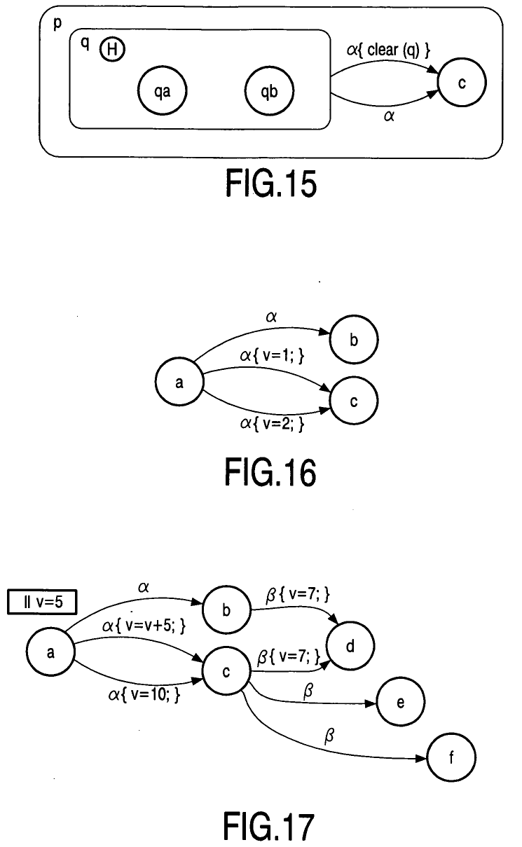

Just as variables can be the distinguishing factors in non-deterministic target states, so can history. In the example of FIG. 15, a transition from state qa under event α leads to the same target state as regards state occupancy. However, since the uppermost shown transition clears the history marker from cluster q and the other transition does not, a different result is obtained for each transition.

According to the invention, different non-deterministic outcomes are represented in a system by ‘worlds’. A world represents the state history etc. result of event processing for every independent ordering choice made from a set of choices occasioned by non-determinism. If any two resultant worlds are identical, one is deleted. When plural worlds exist, the system accepts an event for processing and processes the event in all of the extant worlds.

The embodied system causes the generation and processing of a set of transition sequences based on fork and race-condition non-determinism for each extant world. The processing involves cloning a world so as to represent a sequence uniquely. A world is generated for each unique sequence.

The system allows permutation of set-transit actions, and generates additional worlds for each permutation. The system also allows for mid-transition-flight firing of additional events, which results in additional worlds in which the remainder of the transition algorithm is processed.

The embodied system also has supporting functionality, including the ability to output all transitionable events on request, to provide all state, variable and history data on request, and to validate state, variable, history and/or trace information (e.g. in testing where this information is obtained from a System Under Test) on request.

The need for world generation can arise at one or both of transition selection time and at transition execution time. For example, fork nondeterminism gives rise to multiple transitions, and race non-determinism gives rise to multiple transition sequence orderings. The need for new world generation is evident before each transition is processed, and new worlds could be cloned ready for these alternative transition sequences before starting any transition execution. In practice, though, it is convenient if the new worlds are created deep in transition execution processing. Certain forms of nondeterminism are best detected by the system in mid-processing of a transition, and so new world creation takes place during transition processing. This applies to set-transit nondeterminism, set-action nondeterminism, set-meta-event nondeterminism and fired event nondeterminism.

The invention is applied to a simple case of fork non-determinism, as shown in FIG. 16, as follows. In the Figure, there are three possible transitions from leafstate a on event α, and each results in a different ‘state’ of the machine in the wide sense, i.e. considering history variables. Each possible outcome is represented in a respective separate world. After non-deterministic processing of the transitions on event α, there are three worlds, namely a) a world in state b, b) a world in state c with variable v=1, and c) a world in state c with variable v=2.

The system treats each of these worlds separately, and every subsequent event is processed in each world. If there is subsequent non-determinism in one or more worlds, further worlds are created. The system treats other forms of non-determinism in a similar manner.

If a number of resultant worlds which could potentially be distinct are determined to be identical, then the worlds are merged, i.e. one copy of identical worlds is retained and the others are deleted. The identical worlds may occur after an event has been processed fully. This may happen after the processing of one event, or after several events, as shown in FIG. 17.

In FIG. 17, assuming an initial value of v=5, there are three possible transitions from leafstate a on event α, but two produce the same result of leafstate c and v=10. However, three worlds are generated by the system, and then one of the two identical worlds is deleted. After then processing event β, four worlds result, of which two are identical (leafstate d, v=7). The two identical worlds are then merged, leaving three worlds.

In summary, after any event or events, the worlds produced can be considered as a bag. If any worlds in the bag are identical, the bag is reduced to a set, as described above. Merging is just a bag_to_set operation. For the worlds to be identical, their state occupancy and history and all data (variable values and trace values) must be identical.

The system numbers the worlds sequentially; no ancestry is recorded. World number 1 is special since it contains the initial data (i.e. the state machine model). This is kept as a ‘save area’ to enable resets to be carried out as necessary. The initial action of the state machine model is to clone world 1 data into world 2, and to set up world 2 as a starting point for further processing. On processing an event, a new world-number is created for each derivative world. With the model of FIG. 17, the following occurs. On processing event α: the resulting worldbag is [3,4,5]. The worldbag after reduction to a set is [3,4]. On processing event β: the new world generated from “3” is [6]; and the new worlds generated from “4” are [7,8,9], giving the new worldbag [6,7,8,9]. The worldbag after reduction to a set is [6,8,9]. This is illustrated in FIG. 18.

Although the first derivative world could use its ancestor's number, the embodied scheme facilitates debugging and tracing the progress of event processing. A log with a unique reference to each world is made, to further facilitate this.

A further example of state machine modelling is now given with reference to FIG. 19. In FIG. 19, a cluster m includes leafstates a, b1, b2, c1, c2, c3, d2, d3 and d4. Fork non-determinism exists on event β from leafstate a, an event γ from leafstates b1 and b2, and an event δ from leafstate c2. The state chart can be described thus:

statechart sc(m)
event alpha,beta,gamma,delta;
enum vint {0,..,100000};
vint v=0;

cluster m(a,b1,b2,c1,c2,c3,d2,d3,d4) {alpha-

>m.a{v=0;};}

| state a {beta->b1; beta->b2;} | |
|---|---|
| state b1 {gamma->c1; gamma->c2;} | |
| state b2 {gamma->c2; gamma->c3;} | |
| state c1; | |
| state c2 {delta->d2; | \ |

| | |
|---|---|
| delta->d3{v=v*10+2;}; | \ |
| delta->d3{v=v*10+2;}; | \ |
| delta->d3{v=v*10+3;}; | \ |
| delta->d3{v=v*10+3;}; | \ |
| delta->d4;} | |

state c3;
state d2 {upon enter {v=v*10+1;}}
state d3;
state d4 {upon enter {v=v*10+4;}}

On event α, i.e. on entering the cluster m, world number 2 is created thus:

| | |
|---|---|
| 2 | SHD statechart for world=2 |
| 2 | statechart sc |

| | |
|---|---|
| 2 | cluster m [sc] [s_occ, []] ** |

| | |
|---|---|
| 2 | leafstate a [m, sc] [s_occ, []] ** |
| 2 | leafstate b1 [m, sc] [s_vac, []] |
| 2 | leafstate b2 [m, sc] [s_vac, []] |
| 2 | leafstate c1 [m, sc] [s_vac, []] |
| 2 | leafstate c2 [m, sc] [s_vac, []] |
| 2 | leafstate c3 [m, sc] [s_vac, []] |
| 2 | leafstate d2 [m, sc] [s_vac, []] |
| 2 | leafstate d3 [m, sc] [s_vac, []] |
| 2 | leafstate d4 [m, sc] [s_vac, []] |

| 2 | VHD variable data for world=2 |
|---|---|
| 2 | VAR v [sc] [vardecl, [enumtype, [vint, [sc]]]] |
| =[ex_co, int, 0] | |
| 2 | TRACE1 list =[[], [x], [y]] |
| 2 | TRACE2 list =[[], [p], [q]] |
| 2 | TREV transitionable event =[[beta, [sc]], 0, [], |
| []] | |
| 2 | TREV transitionable event =[[alpha, [sc]], 0, [], |

[]

Here, the asterisks indicate that cluster m and leafstate a are occupied. After processing event β, worlds 3 and 4 exist thus:

| | |
|---|---|
| 3 | SHD statechart for world=3 |
| 3 | statechart sc |

| | |
|---|---|
| 3 | cluster m [sc] [s_occ, []] ** |

| | |
|---|---|
| 3 | leafstate a [m, sc] [s_vac, []] |
| 3 | leafstate b1 [m, sc] [s_vac, []] |
| 3 | leafstate b2 [m, sc] [s_occ, []] ** |
| 3 | leafstate c1 [m, sc] [s_vac, []] |
| 3 | leafstate c2 [m, sc] [s_vac, []] |
| 3 | leafstate c3 [m, sc] [s_vac, []] |
| 3 | leafstate d2 [m, sc] [s_vac, []] |
| 3 | leafstate d3 [m, sc] [s_vac, []] |
| 3 | leafstate d4 [m, sc] [s_vac, []] |

| 3 | VHD variable data for world=3 |
|---|---|
| 3 | VAR v [sc] [vardecl, [enumtype, [vint, [sc]]]] |
| =[ex_co, int, 0] | |
| 3 | TRACE1 list =[[], [x], [y]] |
| 3 | TRACE2 list =[[2], [p], [q]] |
| 3 | TREV transitionable event =[[gamma, [sc]], 0, [], |
| []] | |
| 3 | TREV transitionable event =[[alpha, [sc]], 0, [], |
| []] | |
| 4 | SHD statechart for world=4 |
| 4 | statechart sc |

| | |
|---|---|
| 4 | cluster m [sc] [s_occ, []] ** |

| | |
|---|---|
| 4 | leafstate a [m, sc] [s_vac, []] |
| 4 | leafstate b1 [m, sc] [s_occ, []] ** |
| 4 | leafstate b2 [m, sc] [s_vac, []] |
| 4 | leafstate c1 [m, sc] [s_vac, []] |
| 4 | leafstate c2 [m, sc] [s_vac, []] |
| 4 | leafstate c3 [m, sc] [s_vac, []] |
| 4 | leafstate d2 [m, sc] [s_vac, []] |
| 4 | leafstate d3 [m, sc] [s_vac, []] |
| 4 | leafstate d4 [m, sc] [s_vac, []] |

| 4 | VHD variable data for world=4 |
|---|---|
| 4 | VAR v [sc] [vardecl, [enumtype, [vint, [sc]]]] |
| =[ex_co, int, 0] | |
| 4 | TRACE1 list =[[], [x], [y]] |
| 4 | TRACE2 list =[[2], [p], [q]] |
| 4 | TREV transitionable event =[[gamma, [sc]], 0, [], |
| []] | |
| 4 | TREV transitionable event =[[alpha, [sc]], 0, [], |
| []] | |

outworlds=[3, 4]

In world 3, leafstate b2 is occupied, whereas leafstate b1 is occupied in world 4. On processing event γ, the following results:

| | |
|---|---|
| 5 | SHD statechart for world=5 |
| 5 | statechart sc |

| | |
|---|---|
| 5 | cluster m [sc] [s_occ, []] ** |

| | |
|---|---|
| 5 | leafstate a [m, sc] [s_vac, []] |
| 5 | leafstate b1 [m, sc] [s_vac, []] |
| 5 | leafstate b2 [m, sc] [s_vac, []] |
| 5 | leafstate c1 [m, sc] [s_vac, []] |
| 5 | leafstate c2 [m, sc] [s_occ, []] ** |
| 5 | leafstate c3 [m, sc] [s_vac, []] |
| 5 | leafstate d2 [m, sc] [s_vac, []] |
| 5 | leafstate d3 [m, sc] [s_vac, []] |
| 5 | leafstate d4 [m, sc] [s_vac, []] |

| 5 | VHD variable data for world=5 |
|---|---|
| 5 | VAR v [sc] [vardecl, [enumtype, [vint, [sc]]]] |
| =[ex_co, int, 0] | |
| 5 | TRACE1 list =[[], [x], [y]] |
| 5 | TRACE2 list =[[4, 2], [p], [q]] |
| 5 | TREV transitionable event =[[delta, [sc]], 0, [], |
| []] | |
| 5 | TREV transitionable event =[[alpha, [sc]], 0, [], |
| []] | |
| 6 | SHD statechart for world=6 |
| 6 | statechart sc |

| | |
|---|---|
| 6 | cluster m [sc] [s_occ, []] ** |

| | |
|---|---|
| 6 | leafstate a [m, sc] [s_vac, []] |
| 6 | leafstate b1 [m, sc] [s_vac, []] |
| 6 | leafstate b2 [m, sc] [s_vac, []] |
| 6 | leafstate c1 [m, sc] [s_occ, []] ** |
| 6 | leafstate c2 [m, sc] [s_vac, []] |
| 6 | leafstate c3 [m, sc] [s_vac, []] |
| 6 | leafstate d2 [m, sc] [s_vac, []] |
| 6 | leafstate d3 [m, sc] [s_vac, []] |
| 6 | leafstate d4 [m, sc] [s_vac, []] |

| 6 | VHD variable data for world=6 |
|---|---|
| 6 | VAR v [sc] [vardecl, [enumtype, [vint, [sc]]]] |
| =[ex_co, int, 0] | |
| 6 | TRACE1 list =[[], [x], [y]] |
| 6 | TRACE2 list =[[4, 2], [p], [q]] |
| 6 | TREV transitionable event = [[alpha, [sc]], 0, [], |
| []] | |
| 7 | SHD statechart for world=7 |
| 7 | statechart sc |

| | |
|---|---|
| 7 | cluster m [sc] [s_occ, []] ** |

| | |
|---|---|
| 7 | leafstate a [m, sc] [s_vac, []] |
| 7 | leafstate b1 [m, sc] [s_vac, []] |
| 7 | leafstate b2 [m, sc] [s_vac, []] |
| 7 | leafstate c1 [m, sc] [s_vac, []] |
| 7 | leafstate c2 [m, sc] [s_vac, []] |
| 7 | leafstate c3 [m, sc] [s_occ, []] ** |
| 7 | leafstate d2 [m, sc] [s_vac, []] |
| 7 | leafstate d3 [m, sc] [s_vac, []] |
| 7 | leafstate d4 [m, sc] [s_vac, []] |

| 7 | VHD variable data for world=7 |
|---|---|
| 7 | VAR v [sc] [vardecl, [enumtype, [vint, [sc]]]] |
| =[ex_co, int, 0] | |
| 7 | TRACE1 list =[[], [x], [y]] |
| 7 | TRACE2 list =[[3, 2], [p], [q]] |
| 7 | TREV transitionable event = [[alpha, [sc]], 0, [], |

[]]
outworlds=[5, 6, 7]

Leafstate c2 is occupied in world 5. This world is actually created by transitioning from leafstate b1 and from leafstate b2, but the resulting two worlds are determined to be identical, and so are merged to form world 5. Leafstate c1 is occupied in world 6, and leafstate c3 is occupied in world 7. Thus, worlds 5, 6 and 7 represent all the different possible outcomes of processing event β then event γ.

On processing event δ, the following occurs:

| | |
|---|---|
| 7 | SHD statechart for world=7 |
| 7 | statechart sc |

| | |
|---|---|
| 7 | cluster m [sc] [s_occ, []] ** |

| | |
|---|---|
| 7 | leafstate a [m, sc] [s_vac, []] |
| 7 | leafstate b1 [m, sc] [s_vac, []] |
| 7 | leafstate b2 [m, sc] [s_vac, []] |
| 7 | leafstate c1 [m, sc] [s_vac, []] |
| 7 | leafstate c2 [m, sc] [s_vac, []] |
| 7 | leafstate c3 [m, sc] [s_occ, []] ** |
| 7 | leafstate d2 [m, sc] [s_vac, []] |
| 7 | leafstate d3 [m, sc] [s_vac, []] |
| 7 | leafstate d4 [m, sc] [s_vac, []] |

| 7 | VHD variable data for world=7 |
|---|---|
| 7 | VAR v [sc] [vardecl, [enumtype, [vint, [sc]]]] |
| =[ex_co, int, 0] | |
| 7 | TRACE1 list =[[], [x], [y]] |
| 7 | TRACE2 list =[[3, 2], [p], [q]] |
| 7 | TREV transitionable event =[[alpha, [sc]], 0, [], |
| []] | |
| 6 | SHD statechart for world=6 |
| 6 | statechart sc |

| | |
|---|---|
| 6 | cluster m [sc] [s_occ, []] ** |

| | |
|---|---|
| 6 | leafstate a [m, sc] [s_vac, []] |
| 6 | leafstate b1 [m, sc] [s_vac, []] |
| 6 | leafstate b2 [m, sc] [s_vac, []] |
| 6 | leafstate c1 [m, sc] [s_occ, []] ** |
| 6 | leafstate c2 [m, sc] [s_vac, []] |
| 6 | leafstate c3 [m, sc] [s_vac, []] |
| 6 | leafstate d2 [m, sc] [s_vac, []] |
| 6 | leafstate d3 [m, sc] [s_vac, []] |
| 6 | leafstate d4 [m, sc] [s_vac, []] |

| 6 | VHD variable data for world=6 |
|---|---|
| 6 | VAR v [sc] [vardecl, [enumtype, [vint, [sc]]]] |
| =[ex_co, int, 0] | |
| 6 | TRACE1 list =[[], [x], [y]] |
| 6 | TRACE2 list =[[4, 2], [p], [q]] |
| 6 | TREV transitionable event =[[alpha, [sc]], 0, [], |
| []] | |
| 10 | SHD statechart for world=10 |
| 10 | statechart sc |

| | |
|---|---|
| 10 | cluster m [sc] [s_occ, []] ** |

| | |
|---|---|
| 10 | leafstate a [m, sc] [s_vac, []] |
| 10 | leafstate b1 [m, sc] [s_vac, []] |
| 10 | leafstate b2 [m, sc] [s_vac, []] |
| 10 | leafstate c1 [m, sc] [s_vac, []] |
| 10 | leafstate c2 [m, sc] [s_vac, []] |
| 10 | leafstate c3 [m, sc] [s_vac, []] |
| 10 | leafstate d2 [m, sc] [s_vac, []] |
| 10 | leafstate d3 [m, sc] [s_vac, []] |
| 10 | leafstate d4 [m, sc] [s_occ, []] ** |

| 10 | VHD variable data for world=10 |
|---|---|
| 10 | VAR v [sc] [vardecl, [enumtype, [vint, [sc]]]] |
| =[ex_co, int, 4] | |
| 10 | TRACE1 list =[[], [x], [y]] |
| 10 | TRACE2 list =[[9, 5, 4, 2], [p], [q]] |
| 10 | TREV transitionable event =[[alpha, [sc]], 0, [], |
| []] | |
| 12 | SHD statechart for world=12 |
| 12 | statechart sc |

| | |
|---|---|
| 12 | cluster m [sc] [s_occ, []] ** |

| | |
|---|---|
| 12 | leafstate a [m, sc] [s_vac, []] |
| 12 | leafstate b1 [m, sc] [s_vac, []] |
| 12 | leafstate b2 [m, sc] [s_vac, []] |
| 12 | leafstate c1 [m, sc] [s_vac, []] |
| 12 | leafstate c2 [m, sc] [s_vac, []] |
| 12 | leafstate c3 [m, sc] [s_vac, []] |
| 12 | leafstate d2 [m, sc] [s_vac, []] |
| 12 | leafstate d3 [m, sc] [s_occ, []] ** |
| 12 | leafstate d4 [m, sc] [s_vac, []] |
| 12 | VHD variable data for world=12 |
| 12 | VAR v [sc] [vardecl, [enumtype, [vint, [sc]]]] |

| =[ex_co, int, 3] | |
|---|---|
| 12 | TRACE1 list =[[], [x], [y]] |
| 12 | TRACE2 list =[[11, 5, 4, 2], [p], [q]] |
| 12 | TREV transitionable event =[[alpha, [sc]], 0, [], |

| []] | |
|---|---|
| 16 | statechart sc |
| 16 | cluster m [sc] [s_occ, []] ** |

| | |
|---|---|
| 16 | leafstate a [m, sc] [s_vac, []] |
| 16 | leafstate b1 [m, sc] [s_vac, []] |
| 16 | leafstate b2 [m, sc] [s_vac, []] |
| 16 | leafstate c1 [m, sc] [s_vac, []] |
| 16 | leafstate c2 [m, sc] [s_vac, []] |
| 16 | leafstate c3 [m, sc] [s_vac, []] |
| 16 | leafstate d2 [m, sc] [s_vac, []] |
| 16 | leafstate d3 [m, sc] [s_occ, []] ** |
| 16 | leafstate d4 [m, sc] [s_vac, []] |

| 16 | VHD variable data for world=16 |
|---|---|
| 16 | VAR v [sc] [vardecl, [enumtype, [vint, [sc]]]] |
| =[ex_co, int, 2] | |
| 16 | TRACE1 list =[[], [x], [y]] |
| 16 | TRACE2 list =[[15, 5, 4, 2], [p], [q]] |
| 16 | TREV transitionable event =[[alpha, [sc]], 0, [], |
| []] | |
| 20 | SHD statechart for world=20 |
| 20 | statechart sc |

| | |
|---|---|
| 20 | cluster m [sc] [s_occ, []] ** |

| | |
|---|---|
| 20 | leafstate a [m, sc] [s_vac, []] |
| 20 | leafstate b1 [m, sc] [s_vac, []] |
| 20 | leafstate b2 [m, sc] [s_vac, []] |
| 20 | leafstate c1 [m, sc] [s_vac, []] |
| 20 | leafstate c2 [m, sc] [s_vac, []] |
| 20 | leafstate c3 [m, sc] [s_vac, []] |
| 20 | leafstate d2 [m, sc] [s_occ, []] ** |
| 20 | leafstate d3 [m, sc] [s_vac, []] |
| 20 | leafstate d4 [m, sc] [s_vac, []] |

| 20 | VHD variable data for world=20 |
|---|---|
| 20 | VAR v [sc] [vardecl, [enumtype, [vint, [sc]]]] |
| =[ex_co, int, 1] | |
| 20 | TRACE1 list =[[], [x], [y]] |
| 20 | TRACE2 list =[[19, 5, 4, 2], [p], [q]] |
| 20 | TREV transitionable event =[[alpha, [sc]], 0, [], |

[]]
outworlds=[7, 6, 10, 12, 16, 20]

As can be seen, worlds 6 and 7 have not changed (there is no transition on event δ from either leafstate c1 and c3). However, world 5 has spawned four new worlds, one in state d2 with v=1, one in state d4 with=4, and two in state d3 (one with v=2 and one with v=3). Here, two pairs of identical worlds have merged from the resulting six worlds, resulting in worlds 10, 12, 16 and 20.

State based testing is essentially a matter of processing events in a state machine engine (to provide a test oracle) and in an implementation under test (IUT), and comparing the results. The test here is all the extant worlds. If the results of the IUT match with any one world, then the result is a test pass. If a state is not directly observable, it could be deduced form transition outputs (or traces) but this is not further considered here.

It should be noted that if it is known that an implementation is non-deterministically specified, but is in fact deterministic, then it is possible for the testing technique to be adaptive and to improve its efficiency as the actual behaviour of the IUT is learnt by the system.

FIG. 20 shows a more complex example. In FIG. 20, there is only one event α—the superscript is for reference only. Also, [t] denotes a true condition, [f] denotes a false condition.

Here follows an algorithm for handling non-determinism based on hierarchy prioritisation when there are transitions at several ancestrally-related levels in a hierarchy. The algorithm is easily extended to handle transitions at various levels as further cases of fork non-determinism, and this extension forms part of the invention.

The following quantities are defined in configuration F, under some event α:

T_{α} is the set of all transitions on event α, (whatever their condition and whatever the configuration-state of the statechart).

T_{F,α,true} is the set of all transitions where the associated source/target pre-requisites and transition conditions are true,

T_{F,α,false} is the set of all transitions where the associated pre-requisites and conditions are false,

S_{F,α,true} is the set of source states of transitions on the event under consideration for which at least one associated transition condition is true,

T^{S}_{F,α,true} is the set of transitions from source state s where the associated pre-requisites and conditions are true,

S_{F,α,qual} is the set of source states of transitions on the event under consideration for which at least one associated transition condition is true, and for which the source state qualifies under the hierarchy prioritisation algorithm used to filter out transitions whose source state is hierarchically above the source state of other transitions on the same event, so that only the deepest transitions in any hierarchy could qualify. A state qualifies if there is no transition with a true condition (on the same event) having a source state hierarchically above it,

T_{Fα,α,qual} is the set of all transitions where the associated pre-requisites and conditions are true and which qualify under the hierarchy prioritisation algorithm, and

T_{F,α,disq} is the set of all transitions where the associated pre-requisites and conditions are true but which are disqualified by the hierarchy prioritisation algorithm.

Qualifying transitions come from the outermost statechart layer(s) containing true transitions. This could be reviewed as an exercise to find the outermost layer of the hierarchy that has at least one true transition, in which all true transitions from this layer are qualifying, and all true transitions below this layer are disqualified. This is equivalent to requiring that a true transition is disqualified if there exists a higher layer containing a true transition (on the event being considered), and a true transition is qualifying if there does not exist a higher layer containing a true transition (on the event being considered).

Furthermore,

T^{S}_{F,α,qual} is the set of all transitions from source state s where the associated pre-requisites and conditions are true and which qualify under the hierarchy prioritisation algorithm

T^{*}_{F,α,qual} is the set of sets T^{S}_{F,α,qual}, for all states s in S_{F,α,qual}. Each member set contains all qualifying transitions from the same qualifying source state.

T^{X}_{F,α,qual} is the set of tuples formed by taking the Cartesian product of the sets in T^{*}_{α,qual}. Each tuple contains a qualifying transition from each qualifying source-state. The tuples do not include differing orderings of transitions. These tuples represent fork non-determinism.

T_{F,α,exec} is the set of sequences formed by replacing each tuple in T^{X}_{α,qual} by sequences covering every permutation (i.e. ordering) of the replaced tuple. So each sequence contains an ordering of a qualifying transition from each qualifying source-state. These sequences represent fork and race-condition non-determinism.

Applying this to the state machine of FIG. 20, event α in some configuration F leads to the following quantities:

| | |
|---|---|
| T_{α} | {t1,t2,t3,t4,t5,t6,t7,t8,t9,t10,t11,t12,t13} |
| T_{F,α,true} | {t5,t7,19,t10,t11} |
| T_{F,α,false} | {t1,t2,t3,t4,t6,t12,t13} |
| S_{F,α,true} | {a4,a5b,ba,baaa,baba} |
| T^{a4}_{F,α,true} | {t5,t7} |
| T^{a5b}_{F,α,true} | {t9} |
| T^{ba}_{F,α,true} | {t10,t11} |
| T^{baaa}_{F,α,true} | {t12} |
| T^{baba}_{F,α,true} | {t13} |
| S_{F,α,qual} | {a4,ba} |
| T_{F,α,qual} | {t5,t7,t10,t11} |
| T_{F,α,disq} | {t9,t12,t13} |
| T^{a4}_{F,α,qual} | {t5,t7} |
| T^{ba}_{F,α,qual} | {t10,t11} |
| T*_{F,α,qual} | {{t5,t7}, {t10,t11}} |
| T^{X}_{F,α,qual} | {(t5,t10), (t5,t11), (t7,t10), (t7,t11)} |
| T_{F,α,exec} | {<t5,t10>, <t10,t5>, <t5,t11>, <t11,t5>, |

<t7,t10>, <t10,t7>, <t7,t11>, <t11,t7>}

Set transit non-determinism is not part of transition selection; instead it is handled within the transition processing algorithm described below.

All transition sequences in T_{F,α,exec} are selected by the algorithm. For each of these sequences, a new world (or several worlds) results after execution of the sequence. As new worlds are generated, there could be duplicates, so merging is performed.

Transition processing of the state chart of FIG. 20 is illustrated in FIG. 21, although there are many other ways in which this could be performed.

Set action non-determinism and set-meta-event non-determinism (illustrated in FIGS. 11 and 12) are implemented by deriving the set action/meta-event permutations from the permutations of the enter and exit trees. A set action could be considered as an action in a variable member. It could be a variable assignment, the clearing of history, the writing of a trace or the firing of an event, for example. The permutations may be grouped together according to the level of hierarchy to which they relate.

An example of permutation grouping follows. Supposing there are two actions (although it could be two state changes or meta-events) in one set, called actions a and b, and two in another set, called actions c and d. a and b may be permuted, and c and d permuted, and the a-b groups permuted with the c-d groups, giving resultant permutations:

| | | | |
|---|---|---|---|
| ab cd | ab dc | ba cd | ba dc |
| cd ab | cd ba | dc ab | dc ba |

This can be termed bracketed permutation. Using bracketed permutation, it is possible, if required, to avoid the over-fine permutations which criss-cross across the groups, such as ac bd. Such permutations could lead to excessive world generation.

The invention operates also when the hierarchy prioritisation algorithm described above is reversed so that outer level transitions take priority. Alternatively, algorithms could be used in which there is no filtering.

The state modelling machine described above is included in the explorer 51 of FIG. 2C.

The explorer 51 of FIG. 2C may include a ‘pruner’. An intelligent primer 52 can determine if an IUT is deterministic, i.e. does not display non-deterministic behaviour, from observing its behaviour over one or more tests. The primer 52 on making such a determination is operable to signal to the explorer 51 that only one of the alternatives it generated is required. Accordingly, the explorer 51 deletes the unrequired worlds so that only one world, representing the actual IUT behaviour, is presented. The testing tool chain in effect learns the behaviour of the IUT as it tests, and adapts itself on the-fly. A more advanced form of adaptation which the explorer 51 preferably adopts is to kill the constructs for forks or races or whatever modelling construct gave rise to the rejected worlds. In this way, many or all of the alternatives which are not generated by the IUT but which are allowed by the model will not be generated again in the testing of the IUT.

The invention may be carried out using any suitable computer, such as the personal computer of FIG. 22. The computer 220 comprises a control processing unit 221, which runs a state machine modelling program stored on a hard disk drive 222. During the running of the program, a model of the state machine is built and stored in RAM 223. For each world generated, a separate model is built and stored in the RAM 223. Worlds are deleted as transitions occur and as worlds are merged.

Events, transitions, actions and other processing jobs can be modularised as tasks. Since processing an event under nondeterminism can give rise to a set of transition sequences, to be processed in many worlds, the most general processing call needed is to process a set of task sequences in many worlds. This can be broken down into simpler calls. For example, it is possible to achieve the processing of a list in worlds by processing a head item in the worlds, and then by a recursive call to the routine processing a tail. To process a task in worlds, a task can be processed in a head world, and the task processed in tail worlds by a recursive call to the routine. The simpler and recursive calls are tied together in some way, e.g. by the output worlds of the first being the input worlds to the second, or by both acting on the same worlds. Then, the two sets of intermediate output worlds are merged into one set of output worlds. Recursion ends when the list is reduced to one or zero elements and the “simpler” routine is called on the one task or one world, or an empty list is returned, respectively.

FIG. 23 shows a possible flow diagram of transition processing. In this example, there are many different exit and enter orderings, due to set-transit nondeterminism. These exit and enter sequences, as housekeeping exercises (i.e. changes in state), all produce the same effect, since the ordering has no consequence. Accordingly, the first sequence is selected for processing. Only when actions are executed do differences appear.

1. A method of modelling a state machine, comprising detecting if, from a state, an event gives rise to non-determinism and, if it does, generating a world for at least some of the permutations, and processing the event in each of the worlds.

2. A method as claimed in claim 1, comprising, following processing of the event, identifying identical worlds and disregarding all except one of the identical worlds.

3. A method as claimed in either preceding claim, further comprising processing a further event in all of the extant worlds.

4. A method as claimed in any preceding claim, in which the generating step comprises permuting or taking a selection of permutations of set-actions.

5. A method as claimed in any preceding claim, in which the generating step comprises permuting or taking a selection of permutations of set-meta-events.

6. A method as claimed in any preceding claim, comprising receiving a request for information on the state model from an external program, and responding to the request with the requested information.

7. A method as claimed in any preceding claim, comprising receiving an instruction to process an event, and processing the event in response thereto.

8. A method as claimed in any preceding claim, comprising receiving an instruction to eliminate a world for each of one or more non-deterministic branches, and in response thereto eliminating the specified world or worlds.

9. A method as claimed in any preceding claim, comprising receiving an instruction to refrain from generating a world for one or more non-deterministic branches, and in response thereto refraining from generating the specified branch or branches.

10. A computer program containing instructions for a computer to carry out the method of any of claims 1 to 9.

11. A computer programmed with the computer program of claim 10.

12. Apparatus for modelling a state machine, the apparatus comprising means for detecting if, from a state, an event gives rise to non-determinism and, means responsive to a positive determination for generating a world for at least some of the permutations, and means for processing the event in each of the worlds.

13. Apparatus as claimed in claim 12, comprising means arranged following processing of the event for identifying identical worlds and for disregarding all except one of the identical worlds.

14. Apparatus as claimed in claim 12 or claim 13, comprising means for processing a further event in all of the extant worlds.

15. Apparatus as claimed in any of claims 12 to 14, in which the world generating means comprises means for permuting or taking a selection of permutations of set-actions.

16. Apparatus as claimed in any of claims 12 to 15, in which the world generating means comprises means for permuting or taking a selection of permutations of set-meta-events.

17. Apparatus as claimed in any of claims 12 to 16, comprising means for responding to a request from an external program for information on the state model with the requested information.

18. Apparatus as claimed in any of claims 12 to 17, comprising means responsive to an event-processing instruction for processing an event.
